(19) United States
(12) Patent Application Publication
(10) Pub. No.: US 2004/0147396 A1
(43) Pub. Date: Jul. 29, 2004

(54) Inorganic absorbent composites method for the production thereof and use of the same

(76) Inventors: Andreas M. Richter, Plossnitz (DE); Michael Felicetti, Halle (DE)

Correspondence Address: Stephan A Pendorf, Pendorf & Cutliff, 5111 Memorial Highway, Tampa, FL, 33634-7356, US

(21) Appl. No.: 10/479,379

(22) PCT Filed: May 27, 2002
(86) PCT No.: PCT/DE02/01980

(30) Foreign Application Priority Data
May 28, 2001 (DE) 101 26 394.5

(51) Int. Cl. B01J 20/22

(52) U.S. Cl. 502/401; 540/471

(57) ABSTRACT

The invention relates to novel inorganic absorbent composite consisting of an open-pore, solid, inorganic matrix, comprising cucurbiturils of general formula (I), which are chemically linked in the matrix. Said cucurbiturils form a macrocycle having a cage structure, consisting of n repeating units, wherein n is a whole number 5, 6, 7 or 8, R represents hydrogen or C₁-C₅ alkyl, and X represents O, S or N. X and R can be the same or different. Said composites are produced by reacting cucurbituril with an inorganic matrix-forming agent, such as silica gel, at 15 to 90° C. in a liquid medium. The inventive composites can be used as absorption materials and catalyst supports.

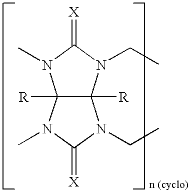

### FIELD OF THE INVENTION

The present invention relates to novel inorganic absorbent composites based on cucurbiturils as well as the production and use of said composites.

### BACKGROUND OF THE INVENTION

Cucurbiturils are macrocycles of the general formula (1). They are characterized by a cyclic cage structure and absorb molecules to or into the macrocycle.

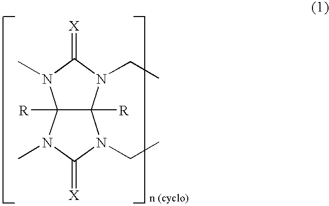

Cucurbit[6]uril (Formula 1, n=6, R═H, X═O) is the representative which has been analysed best while cucurbiturils wherein n=5, R=methyl, X═O and n=5, 6, 7, 8, R═H, X═O are also known. In the case of cucurbit[6]uril (Formula 1, n=6, R═H, X═O), the diameter of the hydrophobic cavity is 550 ppm and the two molecule openings, each of which is formed by 6 carbonyl groups, have a diameter of 400 ppm (Freeman, W. A. et al. J. Am. Chem. Soc. 1983, 103, 7367-7368). Cucurbit[6]uril is produced in the form of a small-particle, amorphous solid which is hardly soluble in organic and inorganic solvents. Its solubility in aqueous saline solutions and acids is higher.

Cucurbit[6]uril forms complexes with a plurality of organic compounds and inorganic cations. Said compounds are complexed at or in the molecule, either in their entiret or in part (so that they form guest-host complexes, see Neugebauer, R. et al. J. Chem. Soc., Perkin Trans. 2, 1998, 529-534).

The complexation is influenced by the chemical structure of the compounds which become attached to or are included into the molecule. Cucurbiturils are therefore very interesting for the selective absorption of substances from solutions.

In Textilveredlung, 1991, 26, 153-157, Buschmann, H.-J. et al. describe successful experiments intended to separate dyes from wastewater using cucurbit[6]uril. The authors also show, however, that cucurbit[6]uril has only a low flow-through rate for dye solutions due to its small particle size. The aforesaid feature is disadvantageous for technical use. In order to increase the absorption of dyes and achieve an acceptable flow-through rate, cucurbit[6]uril can be precipitated onto support materials (e.g. silica gel) (Buschmann, H.-J. et al. publication cited above, pp. 160-162).

For example, cucurbit[6]uril can be precipitated onto silica gel by soaking silica gel M60 with a solution of cucurbit[6]uril in hydrochloric acid (ratio 1:6) and precipitating cucurbit[6]uril by adding water.

In this way, absorbents are obtained which can be used in absorption columns. However, the absorbents produced as described above have disadvantages: If they are repeatedly loaded and regenerated, their active component, i.e. cucurbituril, is washed away, i.e. their durability is very limited. In addition, the capacity of these absorbents is too low.

### SUMMARY OF THE INVENTION

The object of the invention is to provide novel absorption materials incorporating cucurbiturils which have a high absorption capacity and a long durability.

Another object of the invention is to develop support materials having complex-forming properties and an appropriate capability of being regenerated.

Another object of the invention is to provide a method for producing said novel materials.

### DETAILED DESCRIPTION

According to the invention, the aforesaid object is achieved by the production and use of composites comprising cucurbiturils and mixtures thereof in inorganic matrices. Said composites are characterized in that the cucurbiturils are firmly integrated in the inorganic matrix in the form of very small particles. By selecting suitable matrices and appropriate production procedures, a high porosity is achieved, which brings about a high absorption capacity of said composites.

According to the invention, inorganic absorbent composites are therefore provided consisting of an open-pore, solid inorganic matrix comprising cucurbiturils of the general formula (1)

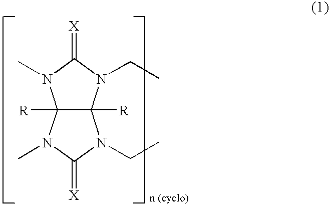

which cucurbiturils are chemically linked within the matrix and form a macrocycle having a cage structure consisting of n repeating units, wherein n is a whole number 5, 6, 7 or 8, R represents hydrogen or C₁-C₅ alkyl and X represents O, S, or N and wherein both X and both R can be the same or different.

The term “chemically linked” refers to both primary valency bonds and secondary valency bonds (van der Waals bonds).

The inorganic matrix of the novel composites is selected from the group consisting of oxidic bodies of silicon, boron, aluminium, phosphorus, titanium, zinc, tin and mixtures thereof. Preferred substances are oxides of silicon, oxides of aluminium, silicates, aluminosilicates and zeolites. The terms “oxides” and “oxidic bodies” also refer to compounds partially containing hydroxides, as in the case of silicon (silica gels) or aluminium (acid aluminas). Silica gels, aluminosilicates, zeolites and oxide mixtures are particularly preferred.

The composite preferably contains a mixture of cucurbiturils according to formula (1), wherein n=5-8, the amount of n=6 ranging between 80 and 85% by weight relative to the mixture as a whole.

R preferably represents methyl, ethyl, propyl or iso-propyl if R represents C₁-C₅ alkyl.

X preferably represents oxygen.

In another embodiment of the invention, the composites are precipitated onto a support material. Such a support material may be e.g. a porous glass, a glass fibre, a glass fabric, a glass wool, a textile support, an activated carbon, a silica gel, a ceramic body or a support commonly used as a catalyst support. Such catalyst supports include e.g. aluminium oxide, silicates, zeolites, kaolin, silica gel, kieselguhr, hydrotalcites, zirconium oxide, titanium oxide, mixtures thereof and macroporous inorganic oxide mixtures.

The cucurbiturils used as starting compounds may be produced e.g. according to DE 100 40 242 A1. In this process, acetylenediurea is added into concentrated sulphuric acid while cooling and subsequently formaldehyde solution is added. Water is neither added nor distilled off. The cucurbituril synthesized in this way, which consists of a mixture of cucurbiturils according to formula (1), wherein n=5-8, is obtained by precipitation in ice water, separation of the precipitate, washing and drying and can be used in this form for the present invention.

The novel composites are coarse solids or small-particle powders, depending upon the production procedure used. For practical use, said novel composites must be shaped in order to adapt them for their intended application. This may be done in a manner known to those of ordinary skill in the art by grinding, sieving, compression moulding, processing them into tablets or applying them onto support materials such as glasses, glass wool, glass fibres or other textile supports.

The aforesaid shaping can be carried out parallel to the formation of the inorganic matrix, e.g. by treating suitable support materials with at least one of the components required for forming the matrix. The actual formation of the matrix then takes place in a following step by the formation of a sol/gel and chemical bonding.

An appropriate shape can also be achieved by combining all the components required for producing the composite, treating a support material with the mixture obtained in this way and finally forming the composite on the support material.

The novel composites are characterized by a high absorption capacity with respect to a plurality of compounds and the absorption process can take place both in the gaseous phase and the liquid phase. Due to the aforesaid feature, the novel composites are particularly suitable for use as absorbents for organic and inorganic pollutants from wastewater.

The absorption behaviour of the novel composites differs depending upon the substance to be taken in. They can therefore be used as active and selective absorbents for chromatographic methods such as gas chromatography and liquid chromatography. A special feature with regard to the absorption process consists in that the cucurbiturils anchored within the porous matrix are hydrophobic in their inner cavity formed by the cyclic structure, whereas the portal groups formed by ═O, ═S or ═N are hydrophilic.

The absorption behaviour of the novel composites can be modified within a wide range by partially or completely complexing the cucurbiturils incorporated therein, which can be particularly interesting for their use as absorbents in chromatographic systems. For example, basic centres can be formed in the composite by the absorption of aliphatic and aromatic amines. If aliphatic and aromatic phosphines are absorbed into the composite, particularly into the cucurbiturils' inner cavity mentioned above, the ligands for the catalysts to be immobilized on said composite can be formed, thus providing catalyst complexes. In this way, the novel composites can also be used for chemical catalysis, either alone or applied onto catalyst support materials.

The cucurbiturils, which bring about absorption into the novel composites, are firmly integrated in the porous matrix thereof by chemical bonds. In this way, the cucurbiturils are prevented from being washed out of the matrix and the number of loading and regenerating cycles can be considerably increased enabling the composites to be commercially utilized.

The absorption materials can be regenerated in various manners, e.g. by extraction with organic or inorganic solvents or by ozonization.

The invention further relates to a method for producing inorganic absorbent composites, which method is characterized by reacting an inorganic matrix-forming agent with a cucurbituril of the general formula (1)

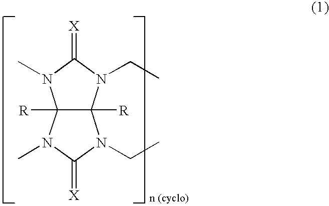

in a liquid medium at a temperature ranging between 15 and 90°C, preferably at room temperature, said cucurbiturils forming a macrocycle having a cage structure consisting of n repeating units, wherein n is a whole number 5, 6, 7 or 8, R represents hydrogen or C₁-C₅ alkyl and X represents O, S, or N and wherein X and R can be the same or different.

The production of said composites is based on the formation of the matrix from the liquid phase, which can be brought about in various manners. In any case, it is essential that at least one of the components (cucurbiturils or matrix-forming agents) be provided in a liquid phase, which may be a solution, an emulsion or a dispersion.

Inorganic matrix-forming agents which may be used include e.g. silicates, silicon compounds, aluminates or aluminium salts, phosphates, borates, titanates or mixtures thereof in the form of solutions or emulsions in organic or inorganic solvents, e.g. water. Said matrix-forming agents form gels when treated with water in an appropriate manner known to those of ordinary skill in the art, which treatment may require the presence of organic solvents and/or acids or bases. The gel formation process often includes a sol stage. The gels obtained can be processed into solid, highly porous matrices for the cucurbiturils, e.g. by drying them at an increased temperature, e.g. at a temperature ranging between 70 and 150° C.

A preferred production process is therefore a sol-gel process, wherein dissolved precursors of the matrix-forming agents are first processed into a sol comprising the discrete, dissolved colloidal particles by hydrolysis and condensation. Said particles then combine establishing covalent links between one another, thus forming a gel. If the solvent is removed, e.g. by drying the moist gel, dimensionally stable, porous bodies are obtained. The pore sizes can be influenced within a wide range by varying pH values and temperatures. For example, different silica gels can be obtained, depending upon the pH value: if the reaction is carried out in an acid environment, small-pore gels are produced, whereas basic conditions lead to medium- and large-pore gels.

The production of the composites will now be explained using cucurbit[6]uril and silica gel as an example.

Cucurbituril dissolves in aqueous solutions of alkali salts and alkaline-earth salts. It therefore dissolves in aqueous solutions of alkali silicates. The solutions obtained are clear, colourless liquids which jelly and form into a gel if inorganic or organic acids are added. Once an appropriate time has passed, said gel is separated by pressing and washed with water in order to remove all ions contained therein. After drying a white, granular mass is obtained which can be shaped by grinding and sieving.

Cucurbituril also dissolves in inorganic and organic acids, e.g. hydrochloric acid or formic acid. The solutions obtained are clear, colourless liquids. The novel composites can be produced by combining a solution of cucurbituril in an acid with a silicon compound according to formula (2)

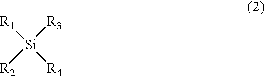

in which formula (2) R₁ to R₄ represent identical or different rests which can be separated by hydrolysis, e.g. alkoxy, phenoxy, halogen, dialkylamino or diarylamino. The composite is produced from the silicon compound, e.g. by means of a sol-gel process, and the cucurbituril precipitated during this process is linked in the matrix in the form of most finely distributed particles.

R₁, R₂, R₃ and R₄ represent identical or different rests which can be separated by hydrolysis, selected from among linear or branched C₁-C₅ alkoxy, phenoxy, halogen, di(C₁-C₄)alkylamino and diarylamino, wherein the alkyl or aryl rests may be substituted, and X represents a group which can be the same or different and which cannot be separated by hydrolysis, selected from among C₁-C₄ alkyl and aryl.

It is preferred that the aryl rest be phenyl.

Halogen may be substituted with fluorine, chlorine, bromine or iodine. Fluorine, chlorine, bromine or iodine may also be used as substituents for the di(C₁-C₄)alkylamino rests in the alkyl part or the diarylamino rests in the aryl part.

In another embodiment, the matrix can be varied within a wide range by replacing the silicon compounds according to formula (2) with silicon compounds according to formulas (3) to (5)

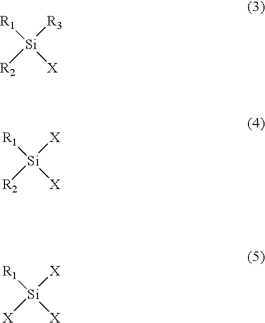

either in their entirety or in part, wherein R₁ to R₃ represent a rest as indicated above and X represents a group which remains linked to Si under the prevailing conditions, e.g. C₁-C₄ alkyl or aryl.

The alkyl rest or the alkyl part in the alkoxy rest can be methyl, ethyl, propyl, isopropyl, n-butyl, i-butyl, t-butyl or pentyl, preferably methyl, ethyl, propyl or i-propyl.

The rest X may also be substituted, for example with fluorine, chlorine, bromine or iodine.

The novel composites can also be produced by adding dispersed cucurbituril into one of the matrix-forming agents mentioned above and subsequently initiating the formation of the inorganic matrix in an appropriate manner by adding acids or bases.

In another embodiment of the invention, the novel composites can also be produced by forming the matrix from hydrolyzable compounds, e.g. silicates, silicon compounds according to formulas (2) and (3), alkali aluminates, phosphates, borates or titanates and mixtures thereof, or from zeolitic synthesis gels in the presence of silica gel or other support materials, e.g. zeolites, clay granules, activated carbon and the like. In this way, the novel composites can be applied onto a plurality of different supports, including commonly used catalyst supports.

Zeolitic synthesis gels consist e.g. of SiO₂, Al₂O₃, Na₂O and water. For example, the composition 100 SiO₂: Al₂O₃: 28 Na₂O:4000H₂O is used for a template-free synthesis of zeolite MFI.

The invention will hereinafter be explained in more detail by means of examples. All amounts are in % by weight unless indicated otherwise.

### EXAMPLE 1

In a beaker, 400 ml water is heated up to 80° C. 30 g sodium silicate is dissolved therein and log cucurbit[6]uril is added. Then 20 ml concentrated hydrochloric acid is added and the precipitate is separated by suction, washed and dried at 100° C. for 24 hours. 63 g of a white solid is obtained which is a composite comprising silica gel and cucurbituril.

### EXAMPLE 2

In a beaker, 0.5 g cucurbituril is dissolved in 50 ml concentrated hydrochloric acid, which cucurbituril corresponds to formula (1), wherein n=5-8, n=6 making up 84% by weight; X represents oxygen; R represents H. Subsequently 51.6 g tetra-ethylsilanol is added and the mixture is stirred for 12 hours (pH=7). The product is separated by suction, washed with water and dried at 100° C. for 12 hours. 16.2 g of a white solid is obtained.

Cucurbituril is produced by reacting 1.03 liters concentrated sulphuric acid with 1.08 kg acetylenediurea while stirring and cooling to 65-70° C. Subsequently 1.752 liters formaldehyde solution (37%) was added within one hour, thus increasing the viscosity of the reaction solution. The solution was heated up to 100-110° C. for 4 hours and then cooled down to room temperature. The clear solution was poured onto 10 kg ice and 15 liters water while stirring and the precipitate was separated by suction. The product was washed with 28 liters water and dried in a drying chamber at 100-130° C. until a constant weight was achieved. 633 g was 50% of the theoretical yield.

### EXAMPLE 3

In a beaker, 0.7 g cucurbituril is dissolved in 75 ml concentrated hydrochloric acid according to Example 2. Subsequently 5 g methoxytriethoxysilane and 40 g tetraethylsilanol is added and the mixture is stirred for 18 hours (pH=2-3). The product is separated by suction, washed with water and dried at 100° C. for 12 hours. 16.2 g of a white solid is obtained.

### EXAMPLE 4

In a beaker, 400 ml water is heated up to 80° C. Subsequently 30 g sodium silicate is dissolved therein and 10 g cucurbituril according to Example 2 is added. A solution of 4 g sodium aluminate in 70 ml water is added, then log sodium hydroxide is added and the mixture is stirred at 70-80° C. for 3 hours (pH=8). The mixture is left to cool, the product is separated by suction and dried at 130° C. 14.5 g of a white solid is obtained.

### EXAMPLE 5

In a beaker, 200 ml water is heated up to 80° C. 15 g sodium silicate is dissolved therein and 5 g cucurbituril according to Example 2 is added. Subsequently 10 ml titanium tetraisopropylate is added dropwise within 30 minutes and the mixture is stirred for 2 hours (pH=3-4) 20 ml concentrated hydrochloric acid is added and then the product is separated by suction, washed and dried at 130° C. for 24 hours. 43 g of a white solid is obtained.

### EXAMPLE 6

In a beaker, 400 ml water is heated up to 80° C. 30 g sodium silicate is dissolved therein and log cucurbituril according to Example 2 is added. Subsequently 20 g silica gel M60 is added, 20 ml concentrated hydrochloric acid is added (pH=2-3) and then the product is separated by suction, washed and dried at 100° C. for 24 hours. 77 g of a white solid is obtained.

### EXAMPLE 7

On a vertical vibrator with analysis sieves (1.00-0.40 mm; 0.40-0.25 mm and 0.25-0.16 mm), sieve cover and sieve pan, 206.5 g of the material obtained according to Example 2 is vibrated for 1 hour. The aforesaid vibration process yields 41.8 g product having a grain size between 1.00 and 0.40 mm, 13.2 g product having a grain size between 0.40 and 0.25 mm, 9.5 g product having a grain size between 0.25 and 0.16 mm and 57.1 g product having a grain size below 0.16 mm.

40 g of the product having a grain size between 0.40 and 0.25 mm was used for the chromatography of a mixture of 30 mg C.I. Acid red 44 and 60 mg Remazol® Brilant Violet 5R in 5 ml water. 75 ml of a Remazol® Brilant Violet 5R solution and 100 ml of a C.I. Acid red 44 solution is obtained.

For comparative purposes, C.I. Acid red 44 and Remazol® Brilliant Violet 5R were separated using silica gel 100 having a grain size of 0.2-0.5 mm, while all the other conditions (amounts and flow-through rate) remained unchanged. No separation could be observed.

A comparison with cucurbit[6]uril precipitated onto silica gel according to the state of the art showed an almost identical separation result in the first and second separation processes, however, a clear decrease was observed after the product had been regenerated 3 to 8 times and the result finally fell to <20%.

What is claimed is:

1. Inorganic absorbent composites consisting of an open-pore, solid, inorganic matrix comprising cucurbiturils of the general formula (1) 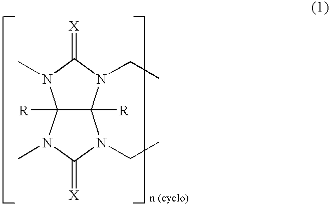
which cucurbiturils are chemically linked within the matrix and form a macrocycle having a cage structure consisting of n repeating units, wherein n is a whole number 5, 6, 7 or 8, R represents hydrogen or C₁-C₅ alkyl and X represents O, S, or N and wherein both X and both R can be the same or different.

2. The composites according to claim 1, wherein the inorganic matrix is selected from the group consisting of oxidic bodies of silicon, boron, aluminium, phosphorus, titanium, zinc, tin and mixtures thereof.

3. The composites according to claim 2, wherein the inorganic matrix is selected from the group consisting of silica gels, aluminium oxides, aluminosilicates and zeolites.

4. The composites according to claim 1, wherein the composites are precipitated onto a support material.

5. The composites according to claim 4, wherein the support material is a porous glass, a glass fibre, a glass fabric, a glass wool, a textile support, an activated carbon, a silica gel, a ceramic body or a commonly used catalyst support.

6. A method for producing inorganic absorbent composites comprising the reaction of an inorganic matrix-forming agent with a cucurbituril of the general formula (1) 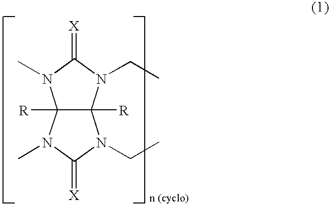
in a liquid medium at a temperature ranging between 15 and 90° C., said cucurbiturils forming a macrocycle having a cage structure consisting of n repeating units, wherein n is a whole number 5, 6, 7 or 8, R represents hydrogen or C₁-C₅ alkyl and X represents O, S, or N and wherein both X and both R can be the same or different.

7. A method according to claim 6, wherein the matrix-forming agent used is a hydrolyzable organic silicon compound, a silicate, aluminate, aluminosilicate, borate, titanate or a mixture thereof or a zeolitic synthesis gel.

8. A method according to claim 7, wherein the organic silicon compound used is a compound according to formulas (2), (3), (4) or (5) 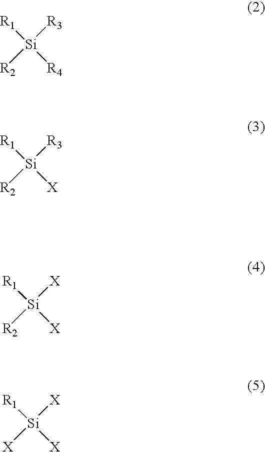
wherein R₁, R₂, R₃ and R₄ represent identical or different rests which can be separated by hydrolysis, selected from among linear or branched C₁-C₅ alkoxy, phenoxy, halogen, di(C₁-C₄)alkylamino and diarylamino, wherein the alkyl or aryl rests may be substituted, and X represents a group which can be the same or different and which cannot be separated by hydrolysis, selected from among C₁-C₄ alkyl and aryl.

9. A method according to claim 6, wherein the liquid medium is selected from the group consisting of a true solution, a dispersion or an emulsion of the matrix-forming agent in an inorganic or organic solvent, a solution of the cucurbiturils or a mixture thereof.

10. A method according to claim 6, wherein the reaction is carried out in the presence of support materials.

11. The use of the composites according to claim 1 as active and selective absorbents for chromatographic methods such as gas chromatography and liquid chromatography.

12. The use of the composites according to claim 1 as a base for the catalyst complexes immobilized thereon.
